(19) United States
(12) Patent Application Publication
(10) Pub. No.: US 2003/0136748 A1
(43) Pub. Date: Jul. 24, 2003

(54) Water purification system

(76) Inventor: John Brian Braithwaite, West Wycombe (GB)

Correspondence Address: Gregory J. Lavorgna, Drinker Biddle & Reath LLP, One Logan Square, 18th & Cherry Streets, Philadelphia, PA, 19103-6996, US

(21) Appl. No.: 10/145,656

(22) Filed: May 14, 2002

(30) Foreign Application Priority Data
Jan. 24, 2002 (GB) 0201545.1

(51) Int. Cl. B01D 36/00

(52) U.S. Cl. 210/806; 210/202; 210/295

(57) ABSTRACT

A water purification system comprises: a water source; a dispenser for dispensing water to fill a container; a conduit connected to the source and the dispenser for the transport of the water from the source to the dispenser; one or more filters interposed between the source and the dispenser for filtering the water that is dispensed to the container; and sanitising apparatus for sanitising the container. The sanitising apparatus comprises a reservoir of disinfectant and distributing apparatus for distributing the disinfectant to the container with the water.

The present invention relates to a water purification system. Particularly, but not exclusively, the present invention relates to a water purification system for the filling of water bottles to be used in conjunction with water coolers.

In many medium-to-large premises, it is common for water coolers to be present to provide potable water to persons using the premises. Typically, these coolers utilise a container of water as the reservoir. The coolers are typically rented from a supplier who also provides the service of supplying the filled water bottles, and removing the empty bottles.

To provide the water for the coolers, the water from a mains source must be further treated. Alternatively, providing the water meets the relevant standards of purity, the water is extracted directly from a natural spring and may or may not undergo further treatment.

To ensure that no foreign substances or harmful bacteria are introduced into the water, the supplier must also sanitise the containers for the water. Typically this is carried out in a separate process such as by the steam cleaning of the bottles.

There are considerable costs involved with the supply of the filled water bottles from the supplier. The filled and empty bottles must be transported between the customer and the supplier.

According to a first aspect of the present invention there is provided a water purification system comprising:

a water source;

a dispenser for dispensing water to fill a container;

a conduit connected to the source and the dispenser for the transport of the water from the source to the dispenser;

one or more filters interposed between the source and the dispenser for filtering the water that is dispensed to the container; and

sanitising apparatus for sanitising the container, comprising a reservoir of disinfectant and distributing apparatus for distributing the disinfectant,

wherein the distributing apparatus distributes the disinfectant to the container with the water.

Preferably the distributing apparatus is connected to the conduit. Preferably the disinfectant is mixed with the water prior to being dispensed to the container. Preferably the disinfectant comprises Aqua Dosa™ sanitising fluid. Preferably the sanitising apparatus further comprises a pump for urging the disinfectant towards the conduit. Preferably the sanitising apparatus further comprises measuring apparatus for distributing a specified volume of disinfectant to the conduit. Preferably the measuring apparatus controls operation of the pump and ceases to operate the pump when a specified volume of disinfectant has been distributed. Preferably the conduit and the distributing apparatus comprise pipe-work.

Preferably the water source is the mains supply system. Alternatively, the water source may comprise a tank and pressure apparatus to urge the water from the source towards the dispenser.

Preferably said one or more filters comprises a main filter and an Ultra-Violet filter. Preferably the main filter is a chemical filter. Preferably said one or more filters further comprises a particulate filter. The particulate filter may be positioned before the main filter. Alternatively, the particulate filter may be positioned between the main filter and the UV filter.

Preferably a non-return valve is interposed between the water source and the or each filter to prevent water flowing from the or each filter to the source. Preferably an isolating valve is also interposed between the water source and the or each filter which, when actuated, prevents the flow of water in either direction between the or each filter and the source. Preferably the dispenser comprises a tap valve.

Preferably the water purification system further comprises a control system. Preferably the control system comprises at least one sensor and the isolating valve may be actuated by a signal from the or each sensor. Preferably a dispenser sensor is provided such that the isolating valve is actuated when the container is full. Preferably a pump sensor is provided such that the isolating valve is actuated when pump failure is detected. Preferably a reservoir sensor is provided and the pump is adapted to cease operation when a specified volume of disinfectant has been distributed. Preferably the dispenser sensor is also connected to the pump and the pump is further adapted such that operation cannot resume until the container is full. Preferably at least one UV filter sensor is provided such that the isolating valve is actuated when UV filter failure is detected.

Preferably the water purification system further comprises status indication devices. Preferably, the signal from one or more sensors is connected to the status indication devices. Preferably the water purification system further comprises an electrical supply and the signal from the or each sensor is an electrical signal. Preferably the isolating valve is actuated in the event that the electrical supply is interrupted.

Preferably the water purification system further comprises a drainage system. Preferably water is directed through the or each filter in a first direction. Preferably the control system is adapted to allow water from the source to be directed through the or each filter and towards the drainage system in a second direction opposite to the first direction. Preferably the control system is further adapted to prevent filling of the container when water is directed in the second direction.

Preferably the water purification system further comprises a flow meter for gauging the volume of water used by the system.

According to a second aspect of the present invention there is provided a method of purifying water comprising the steps of:

directing water from a water source to a dispenser for dispensing the water to fill a container via a conduit connected to the source and the dispenser;

providing one or more filters interposed between the source and the dispenser for filtering the water that is dispensed to the container; and

providing sanitising apparatus for sanitising the container, comprising a reservoir of disinfectant and distributing apparatus for distributing the disinfectant,

wherein the distributing apparatus distributes the disinfectant to the container with the water.

Preferably the distributing apparatus is connected to the conduit. Preferably the disinfectant comprises Aqua Dosa™ sanitising fluid. Preferably the sanitising apparatus further comprises measuring apparatus for distributing a specified volume of disinfectant to the conduit.

Preferably said one or more filters comprises a main filter and an Ultra-Violet filter. Preferably the main filter is a chemical filter. Preferably said one or more filters further comprises a particulate filter.

Preferably the water purification system further comprises a control system.

According to a third aspect of the present invention there is provided a water purification system comprising:

a water source;

a dispenser for dispensing water to fill a container;

a conduit connected to the source and the dispenser for the transport of the water from the source to the dispenser;

one or more filters interposed between the source and the dispenser for filtering the water that is dispensed to the container; and

sanitising apparatus for sanitising the container, comprising a disinfectant,

wherein the disinfectant is introduced to the water after the water has been filtered.

Preferably the disinfectant comprises Aqua Dosa™ sanitising fluid. Preferably the sanitising means further comprises measuring apparatus.

Preferably said one or more filters comprises a main filter and an Ultra-Violet filter. Preferably the main filter is a chemical filter. Preferably said one or more filters further comprises a particulate filter.

Preferably the water purification system further comprises a control system.

According to a fourth aspect of the present invention there is provided a method of purifying water comprising the steps of:

directing water from a water source to a dispenser for dispensing water to fill a container via a conduit connected to the source and the dispenser;

providing one or more filters interposed between the source and the dispenser for filtering the water that is dispensed to the container; and

providing sanitising apparatus for sanitising the container, comprising a disinfectant,

wherein the disinfectant is introduced to the water after the water has been filtered.

Preferably the disinfectant comprises Aqua Dosa™ sanitising fluid. Preferably the sanitising means further comprises measuring apparatus.

Preferably said one or more filters comprises a main filter and an Ultra-Violet filter. Preferably the main filter is a chemical filter. Preferably said one or more filters further comprises a particulate filter.

Preferably the water purification system further comprises a control system.

An embodiment of the present invention will now be described by way of example only with reference to the accompanying drawings in which:

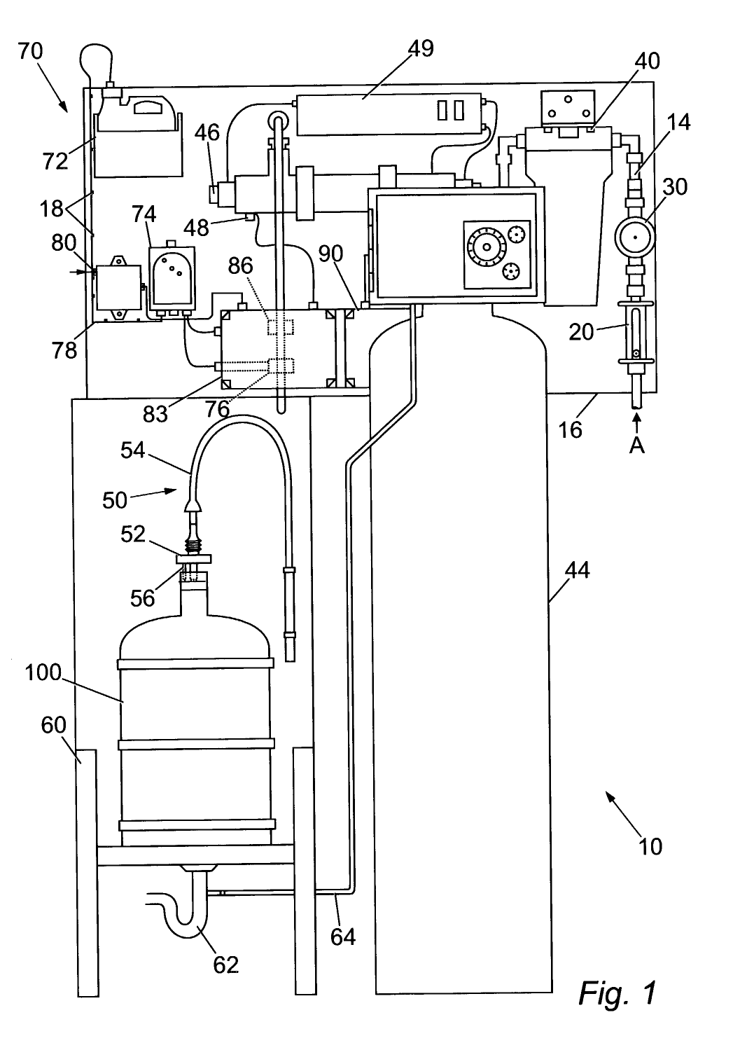

FIG. 1 is a front view of the water purification system;

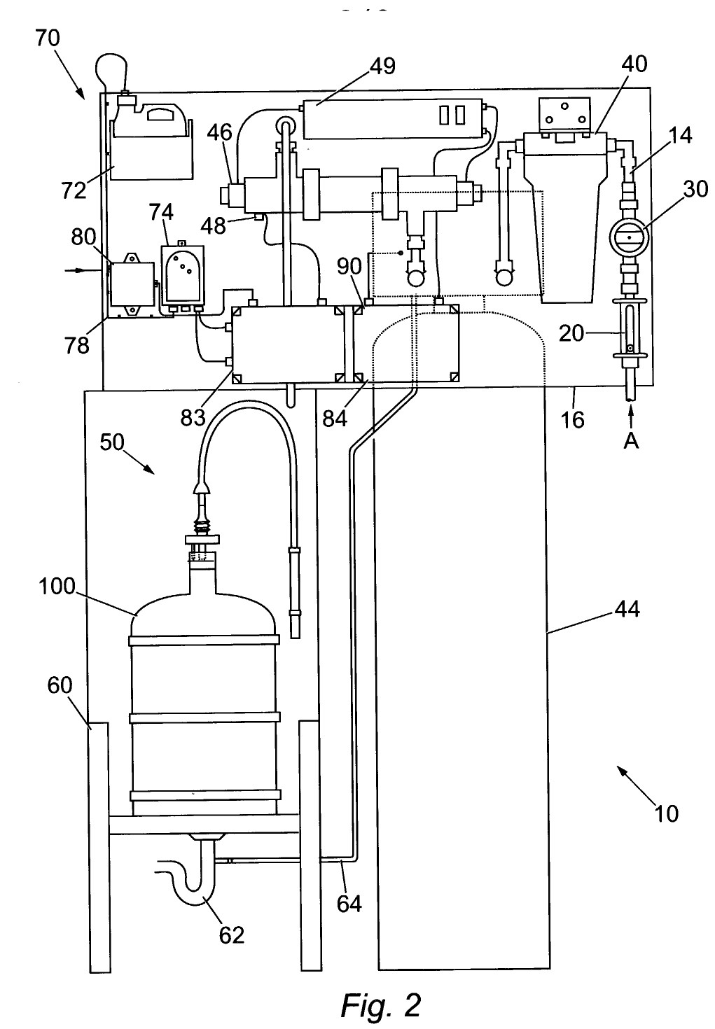

FIG. 2 is a front view of the system of FIG. 1 with some of the elements in outline; and

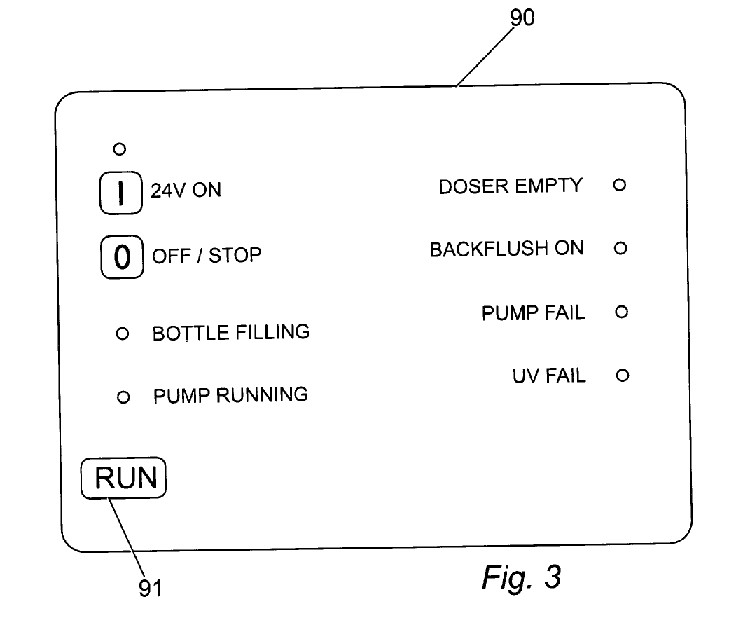

FIG. 3 is a front view of a component of the system of FIG. 1.

Referring to FIGS. 1 and 2, water enters the purification system 10 from a source (not shown) and travels in a direction shown in the figure as ‘A’. The water enters the system 10 under mains pressure, typically between 2 and 8 bar, and travels through the system 10 at a typical rate of 8 litres per minute. The water travels via a conduit 14 in the form of pipe-work, typically having an internal diameter of 13 mm. However, any suitable conduit means can be used to convey the water.

The water first flows through a manual shut off valve 20. The water then passes through a flow meter 30 that measures the quantity of water used before entering a particulate filter 40. Both the manual shut off valve 20, the flow meter 30, and the particulate filter 40 are mounted on a main equipment board 16.

The particulate filter 40 is constructed of a wound nylon fabric and is adapted to remove particulates of a size of five microns or greater. Water exiting the particulate filter 40 then enters the main filter 44. Alternatively, the particulate filter 40 may be positioned after the main filter 44.

The main filter 44 is a chemical filter and has a 67 litre capacity. Due to the size of this filter 44, the main filter 44 is free standing. This filter 44 can remove a number of contaminates such as herbicides, pesticides, odours, and smaller particulates down to one micron is size. Water passing from the main filter 44 then enters a UV filter 46.

The UV filter 46 has a UV lamp which produces ultra-violet light. This is particularly effective in killing any infectious organisms including viruses. The UV filter 46 is mounted on the equipment board 16 and is powered by a power unit 49 connected to the electrical supply (described below). The filtered water then travels to the dispenser 50.

Although in the described example three filters are provided, it is to be understood that one, two, four or more separate filters may be provided.

The dispenser 50 comprises a stainless steel cap assembly 52 adapted to fit a conventional 19 litre water bottle 100 or other suitable container. The dispensing cap 52 is connected to the pipe-work 14 by an armoured hose line 54.

The water bottle 100 is positioned on top of a bottle rack 60 of stainless steel construction. The rack includes a drain 62 for any over-spill.

Connected to the pipe-work 14 between the filters 40, 44, 46 and the dispenser 50 is the container sanitising apparatus 70. A reservoir of five litres of disinfectant is provided in a container 72 mounted on the equipment board 16. Distributing apparatus are provided to distribute the disinfectant to the pipe-work 14.

The disinfectant is Aqua Dosa™ sanitising fluid. Aqua Dosa™ consists of calloid silver, which has a strong oxidising capacity, and hydrogen peroxide. Exposure to light should be avoided and so the container 72 is opaque. A pump 74 is provided to direct the disinfectant from the container 72 to a mixing valve 76 connected to the pipe-work 14. The disinfectant travels from the container 72 via flexible tubing 78 which is fastened to the equipment board 16 using adhesive fasteners 18.

An electrically controlled isolating valve 86 is provided at the mixing valve 76. The isolating valve 86 is adapted such that it is open only if it receives an electrical supply and is operated by the signal from a number of sensors (discussed below). The mixing valve 76 and the isolating valve 86 and mounted within an enclosure 83.

Electrical power for the isolating valve 86 and other components, such as sensors, is provided by a transformer 80 connected to the main supply. This provides 24 volts dc. Circuit breakers (not shown) are provided to interrupt the electrical supply in the event of electrical spikes or other forms of irregular supply. The circuit breakers are mounted within a splash-proof enclosure 84 (shown more clearly in FIG. 2).

The system 10 also includes a number of sensors. A sensor 56 is provided at the dispenser cap 52 for detecting when the bottle 100 is full. In such an event a signal is sent to the isolating valve 86 to close.

The pump 74 is adapted to carry out ten revolutions for each filling cycle. Each revolution draws 1 ml of disinfectant into the pipe-work 14 containing the filtered water. After 10 ml has been distributed, the pump 74 ceases operation. A sensor (not shown) in the disinfectant reservoir monitors the level of disinfectant to ensure that the correct quantity is being distributed. A signal from the dispenser sensor 56 is also sent to the pump 74 to allow the pump 74 to resume operation. This arrangement prevents the possibility of a double dose of disinfectant being added to the same bottle of water.

A sensor 48 is also provided at the UV filter 46 so that, in the event that the lamp fails, or any other circumstance which leads to no ultra violet light being produced, a signal is sent to the isolating valve 86 to close. The isolating valve 86 is arranged such that the valve 86 will fail safe, that is, it will close in the event of an interruption of the electrical supply.

The signals from the sensors are connected to a display board 90 to inform the user of failure of any part of the system. The display board 90 is shown more clearly in FIG. 3. An operating switch 91 is provided on the display board 90 to allow the user to begin each filling cycle. The display board 90 is mounted on the face of the enclosure 84 housing the circuit breakers.

The operation of each filling cycle will now be described.

The user utilises the operating switch on the display board 90 to allow the filling of the bottle 100 to commence. Water passes through the three filters 40, 44, 46 and the associated pipe-work 14 to the mixing valve 76.

At the same time the pump 74 is activated and the pump 74 performs ten revolutions. This draws 10 ml of disinfectant from the reservoir 72 to the mixing valve 76. The water and disinfectant are mixed and the resultant fluid travels to the dispenser 50 and is then dispensed to the bottle 100.

Once 19 litres of water, including the disinfectant, has been dispensed, the dispenser sensor 56 will be activated. A signal will be sent for the isolating valve 86 to close and the pump 74 is also sent a signal to reset.

The disinfectant in the bottle 100 acts upon the interior surface of the bottle 100 to sanitise it. The turbulence created during the filling helps to disperse the disinfectant in the water so that disinfectant contacts the whole surface of the bottle 100. The display board 90 informs the user that the bottle 100 is completely filled. The user then removes the dispenser cap 52 and a self-sealing cap (not shown) is fitted to the bottle 100. Aqua Dosa™ breaks down to form water and oxygen, leaving only traces of any other chemicals, and so the final product is potable.

It should be appreciated that the system 10 allows the automatic filling and sanitising of the bottle 100 without requiring any further input from the user. This ensures that a bottle 100 cannot remain in a non-sanitised condition due to operator error.

To ensure that the system 10 continues to provide filtered water and a sanitised bottle 100 to an acceptable standard, servicing of the system 10 is carried out, typically every six months. The reservoir for disinfectant 72 can be re-filled by the user. The reservoir sensor co-operates with the isolating valve 86 so that the system 10 will not operate in the event that the reservoir 72 is 10% full or less. During servicing, the UV bulb for the UV filter 48 and the media for the particulate filter 40 are changed. The pipe-work 14 for the filtering system can be sanitised using chlorinated water or ozone being passed through the system. The main filter 44 has a back flushing capability. Water is passed in the opposite direction to that during normal use. Water exiting the main filter is this case is directed to the drainage system 62 via a drain pipe 64. The media of the main filter 44 may be changed during every second servicing visit.

Other checks during servicing may include the checking of all pipes and joints, replacement of the parastelic pump tube, and the noting of meter readings. The meter readings can be used to adjust the back flushing of the main filter 44 to cope with the volume of water being used.

Variations and modifications can be made to the embodiment herein described without departing from the scope of the invention. For example, the conduit 78 for the disinfectant may not be connected to the pipe-work 14 for the water but may instead be dispensed directly to the bottle 100. The disinfectant may be dispensed as the bottle 100 is being filled with water, or at a time before or after the bottle 100 is filled.

1. A water purification system comprising:
a water source;
a dispenser for dispensing water to fill a container;
a conduit connected to the source and the dispenser for the transport of the water from the source to the dispenser;
one or more filters interposed between the source and the dispenser for filtering the water that is dispensed to the container; and
sanitising apparatus for sanitising the container, comprising a reservoir of disinfectant and distributing apparatus for distributing the disinfectant,
wherein the distributing apparatus distributes the disinfectant to the container with the water that is dispensed to the container.

2. The water purification system according to claim 1, wherein the distributing apparatus is connected to the conduit and the disinfectant is mixed with the water prior to being dispensed to the container.

3. The water purification system according to claim 1, wherein the disinfectant comprises Aqua Dosa™ sanitising fluid.

4. The water purification system according to claim 2, wherein the sanitising apparatus further comprises:
a pump for urging the disinfectant towards the conduit; and
measuring apparatus adapted to control operation of the pump for distributing a specified volume of disinfectant to the conduit.

5. The water purification system according to claim 1, wherein said one or more filters comprises a main filter and an Ultra-Violet filter.

6. The water purification system according to claim 5, wherein said one or more filters further comprises a particulate filter.

7. The water purification system according to claim 1, wherein an isolating valve is also interposed between the water source and the or each filter which, when actuated, prevents the flow of water in either direction between the or each filter and the source.

8. The water purification system according to claim 7, including a control system comprising at least one sensor and the isolating valve may be actuated by a signal from the or each sensor.

9. The water purification system according to claim 8, wherein the control system includes a reservoir sensor and the reservoir sensor and pump co-operate such that the pump ceases operation when a specified volume of disinfectant has been distributed.

10. The water purification system according to claim 1, further comprising status indication devices.

11. The water purification system according to claim 1, further comprising a drainage system.

12. A method of purifying water comprising the steps of:
directing water from a water source to a dispenser for dispensing water to fill a container via a conduit connected to the source and the dispenser;
providing one or more filters interposed between the source and the dispenser for filtering the water that is dispensed to the container; and
providing sanitising apparatus for sanitising the container, comprising a reservoir of disinfectant and distributing apparatus for distributing the disinfectant,
wherein the distributing apparatus distributes the disinfectant to the container with the water.

13. The method of purifying water according to claim 12, wherein the disinfectant comprises Aqua Dosa™ sanitising fluid.

14. A water purification system comprising:
a water source;
a dispenser for dispensing the water to fill a container;
a conduit connected to the source and the dispenser for the transport of water from the source to the dispenser;
one or more filters interposed between the source and the dispenser for filtering the water that is dispensed to the container; and
sanitising apparatus for sanitising the container, comprising a disinfectant,
wherein the disinfectant is introduced to the water after the water has been filtered.

15. The water purification system according to claim 14, wherein the disinfectant comprises Aqua Dosa™ sanitising fluid.

16. The water purification system according to claim 14, wherein said one or more filters comprises a main filter and an Ultra-Violet filter.

17. A method of purifying water comprising the steps of:
directing water from a water source to a dispenser for dispensing water to fill a container via a conduit connected to the source and the dispenser;
providing one or more filters interposed between the source and the dispenser for filtering the water that is dispensed to the container; and
providing sanitising apparatus for sanitising the container, comprising a disinfectant,
wherein the disinfectant is introduced to the water after the water has been filtered.

18. The method of purifying water according to claim 17, wherein the disinfectant comprises Aqua Dosa™ sanitising fluid.
